(19) United States
(12) Patent Application Publication
(10) Pub. No.: US 2025/0013267 A1
(43) Pub. Date: Jan. 9, 2025

(54) ELECTRONIC APPARATUS

(71) Applicant: Lenovo (Singapore) Pte. Ltd., Singapore (SG)

(72) Inventors: Akashi Takashima, Kanagawa (JP); Tatsuya Ushioda, Kanagawa (JP)

(73) Assignee: Lenovo (Singapore) Pte. Ltd., Singapore (SG)

(21) Appl. No.: 18/738,250

(22) Filed: Jun. 10, 2024

(30) Foreign Application Priority Data
Jul. 6, 2023 (JP) 2023-111684

(51) Int. Cl. G06F 1/16

(52) U.S. Cl. CPC G06F 1/1656; G06F 1/1681; G06F 1/1683

(57) ABSTRACT

An electronic apparatus includes: a first chassis; a second chassis; a hinge connecting the first chassis and the second chassis relatively rotatably; and a flat cable provided across the first chassis and the second chassis. In the first chassis, the flat cable forms: a first extending portion extending toward a first edge of the first chassis connected to the second chassis; a second extending portion extending from the first extending portion through a first curved portion toward a side opposite to the first edge; and a third extending portion extending from the second extending portion through a second curved portion toward the first edge. The second extending portion is fixed.

### CROSS-REFERENCE TO RELATED APPLICATIONS

This application claims priority to Japanese Patent Application No. 2023-111684 filed on Jul. 6, 2023, the contents of which are hereby incorporated herein by reference in their entirety.

### TECHNICAL FIELD

The present invention relates to an electronic apparatus in which a first chassis and a second chassis are relatively rotatably connected by a hinge.

### BACKGROUND

In a laptop personal computer (PC), a main body chassis and a display chassis are relatively rotatably connected by a hinge. Flat cables such as FPCs have excellent flexibility, are bendable, have a high degree of freedom in routing, and are thin, and accordingly are sometimes used in electronic apparatuses including flat chassis, such as laptop PCs. Japanese Unexamined Patent Application Publication No. 2022-121092 discloses connecting two chassis using an FPC. In the technique described in Japanese Unexamined Patent Application Publication No. 2022-121092, since the route length required of the FPC changes as the rotation angle between the two chassis changes, an S-shaped extra length portion for absorbing such changes is provided in one chassis.

The S-shaped extra length portion absorbs changes in route length by changing the bending angles of a plurality of curved portions. However, since the shapes of the plurality of curved portions each have a tolerance, there is concern that the extra length portion as a whole cannot maintain the expected shape and the desired result cannot be ensured. In such a case, initial position setting for assembly is difficult, and the possibility that the degree of curvature becomes severe locally and stress is applied, contact with an unexpected part occurs and abnormal noise is generated, or part of the FPC protrudes from the gap between the chassis arises. This requires thorough inspection and possibly reassembly.

### SUMMARY

One or more embodiments of the present invention is an electronic apparatus in which an extra length portion in a flat cable can be maintained in an appropriate route to absorb changes in route length associated with changes in the rotation angle between chassis.

An electronic apparatus according to one or more embodiments of the present invention is an electronic apparatus including: a first chassis; a second chassis; a hinge connecting the first chassis and the second chassis relatively rotatably; and a flat cable provided across the first chassis and the second chassis, wherein in the first chassis, the flat cable forms: a first extending portion extending toward a first edge of the first chassis connected to the second chassis; a second extending portion extending from the first extending portion through a first curved portion toward a side opposite to the first edge; and a third extending portion extending from the second extending portion through a second curved portion toward the first edge, and wherein the second extending portion is fixed.

According to one or more embodiments of the present invention, an extra length portion in a flat cable can be maintained in an appropriate route to absorb changes in route length associated with changes in the rotation angle between chassis.

### BRIEF DESCRIPTION OF THE DRAWINGS

FIG. 1 is a schematic plan view of an electronic apparatus according to one or more embodiments as seen from above.

FIG. 2 is a sectional side view of a flat cable and its surroundings in the electronic apparatus in a state in which the rotation angle between the chassis is 0 degrees.

FIG. 3 is a perspective view of the flat cable and its surroundings in the main body chassis with the bottom cover member removed.

FIG. 4 is an exploded perspective view of the flat cable and its surroundings in the main body chassis with the bottom cover member removed.

FIG. 5 is a perspective view of the same part as in FIG. 3 with the flat cable removed.

FIG. 6 is a sectional side view of the flat cable and its surroundings in the electronic apparatus in a state in which the rotation angle between the chassis is 100 degrees.

FIG. 7 is a sectional side view of the flat cable and its surroundings in the electronic apparatus in a state in which the rotation angle between the chassis is 180 degrees.

### DETAILED DESCRIPTION OF THE INVENTION

Embodiments of an electronic apparatus according to the present invention will be described in detail below, with reference to the drawings. The present invention is not limited by these embodiments.

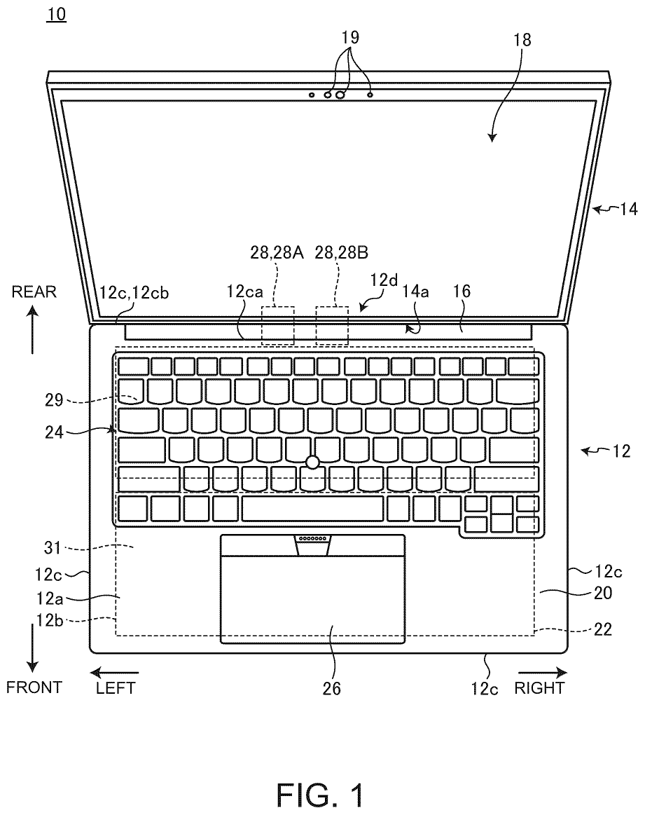

FIG. 1 is a schematic plan view of an electronic apparatus 10 according to one or more embodiments as seen from above. As illustrated in FIG. 1, the electronic apparatus 10 is a clamshell laptop PC in which a main body chassis 12 and a display chassis 14 are relatively rotatably connected by a hinge 16. The electronic apparatus according to the present invention is not limited to a laptop PC, and may be, for example, a foldable tablet PC.

The display chassis 14 is a flat box body thinner than the main body chassis 12. A display 18 is mounted on the display chassis 14. The display 18 is composed of, for example, organic EL (organic light emitting diode (OLED)) or liquid crystal. A plurality of electronic devices 19 are mounted on the upper side of the display chassis 14. The electronic devices 19 include a camera, a microphone, and an infrared device.

The main body chassis 12 and each component mounted in the main body chassis 12 will be described below. Hereafter, based on a posture of viewing the display 18 with the chassis 12 and 14 opened at a predetermined angle as illustrated in FIG. 1, the near side is referred to as “front”, the far side as “rear”, the width direction as “left-right direction”, and the thickness direction as “top-bottom direction”.

The main body chassis 12 is a flat box body. The main body chassis 12 is formed in a box shape by a top cover member 20 forming a top surface 12a and a bottom cover member 22 forming a bottom surface 12b and four peripheral side surfaces 12c. The cover members 20 and 22 are overlapped in the thickness direction and removably connected to each other. The bottom cover member 22 at the bottom has a substantially bathtub shape with an open top surface. The top cover member 20 at the top has a substantially flat plate shape and serves as a lid that closes the top opening of the bottom cover member 22. A keyboard 24 and a touch pad 26 are provided on the top surface 12a of the main body chassis 12.

The hinge 16 relatively rotatably connects a rear edge portion (first edge) 12d of the main body chassis 12 and one edge portion (second edge) 14a of the display chassis 14 adjacent to the rear edge portion 12d. Suppose the state in which the chassis 12 and 14 are stacked and the clamshell is closed is 0 degrees. Then, the angle range in which the chassis 12 and 14 are rotatable by the hinge 16 in one or more embodiments is 0 degrees to 180 degrees. The rotation angle between the chassis 12 and 14 may be smaller than 180 degrees.

A motherboard 29, a battery device 31, and the like are mounted inside the main body chassis 12. The motherboard 29 is the main board in the electronic apparatus 10. The motherboard 29 is located near the rear of the main body chassis 12. Various electronic components such as a CPU, a GPU, power components, communication modules, memory, and connection terminals are mounted on the motherboard.

The electronic apparatus 10 includes two flat cables 28A and 28B provided across the main body chassis 12 and the display chassis 14. Although the flat cables 28A and 28B are parallel to each other approximately at the center, the flat cables 28A and 28B may be separated to the left and right. The flat cables 28A and 28B are also collectively referred to as “flat cable 28”. The number of flat cables 28 may be one, or three or more. The flat cable 28 has one end connected to the motherboard 29 or a subboard in the main body chassis 12, and the other end connected directly or indirectly to the display 18 or the electronic device 19 in the display chassis 14. The flat cable 28 is a flexible printed circuit (FPC). A FPC is formed of a thin sheet or film composed of a polyimide layer, a conductive layer, and the like and has excellent flexibility, and also has a certain degree of elasticity so as to return to its original shape from a bent state. The flat cable 28 may be a flexible flat cable (FFC) or the like.

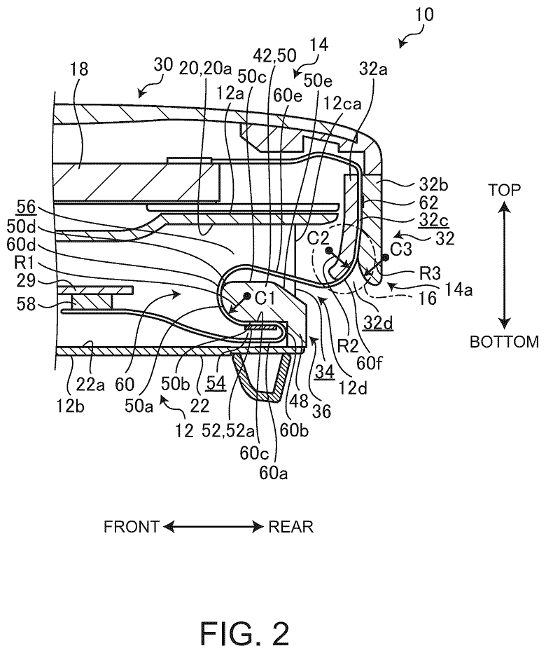

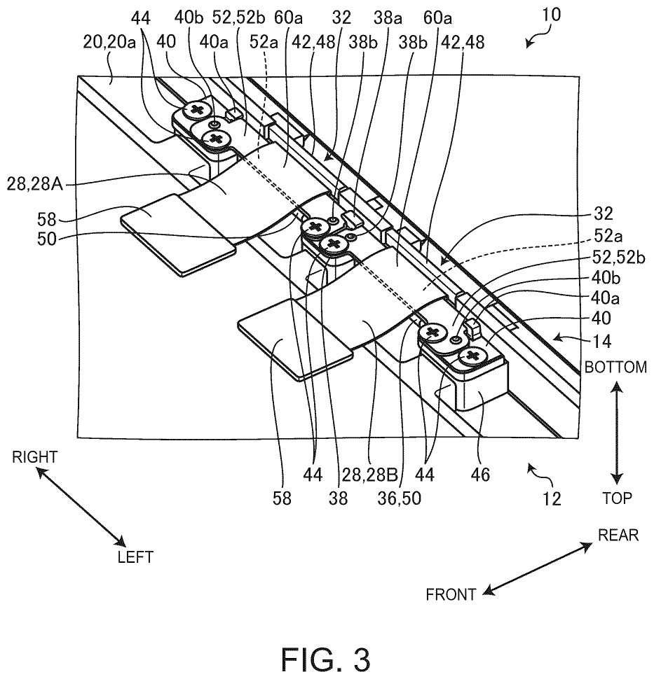

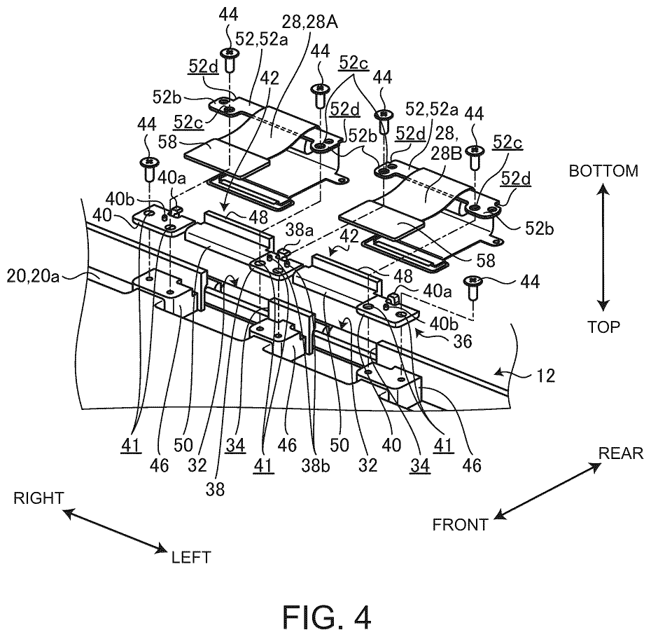

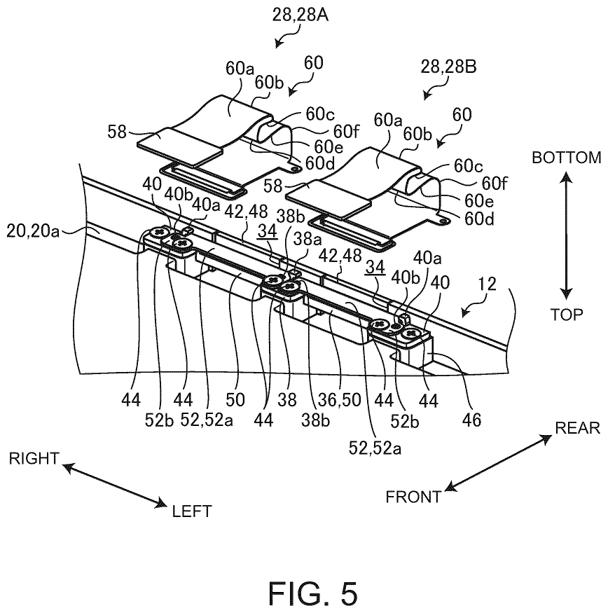

FIG. 2 is a sectional side view of the flat cable 28 and its surroundings in the electronic apparatus 10 in a state in which the rotation angle between the chassis 12 and 14 is 0 degrees. FIG. 3 is a perspective view of the flat cable 28 and its surroundings in the main body chassis 12 with the bottom cover member 22 removed. FIG. 4 is an exploded perspective view of the flat cable 28 and its surroundings in the main body chassis 12 with the bottom cover member 22 removed. FIG. 5 is a perspective view of the same part as in FIG. 3 with the flat cable 28 removed. Although the electronic apparatus 10 as an actual product or in an assembly stage will not have only the flat cable 28 removed as illustrated in FIG. 5, the illustration in FIG. 5 is intended to make a cable guide 36 and a bracket 52 easily recognizable.

In the description of the display chassis 14 with reference to FIG. 2, the state illustrated in FIG. 2 in the top-bottom direction is used as a reference. The display chassis 14 includes a flat plate portion 30 including the display 18, and a hinge attachment portion (bent portion) 32 that is bent from the rear end of the flat plate portion 30 and connected to the hinge 16 at a position facing the rear side surface 12ca of the main body chassis 12. Thus, the display chassis 14 is drop-down type. The hinge attachment portion 32 extends in the top-bottom direction. The hinge attachment portion 32 includes an inside member 32a on the side facing the rear edge portion 12d and an outside member 32b on the opposite side, and a slit-like cable hole 32c through which the flat cable 28 passes is formed between the inside member 32a and the outside member 32b. The cable hole 32c in the hinge attachment portion 32 forms a cable opening 32d at one edge portion 14a. In the state illustrated in FIG. 2, the cable opening 32d is located slightly below the center of the hinge 16 and at approximately half the thickness of the main body chassis 12.

The inside member 32a is slightly thinner than the outside member 32b. The inside member 32a is curved slightly forward in the downward direction. The outside member 32b extends slightly below the inside member 32a. At the cable opening 32d, the inside member 32a and the outside member 32b form respective circular arcs so as to widen from each other toward the opening. The radius R2 of the circular arc surface of the inside member 32a and the radius R3 of the circular arc surface of the outside member 32b at the cable opening 32d are equal, for example, 2.5 mm. The circular arc center C2 of the circular arc surface of the inside member 32a and the circular arc center C3 of the circular arc surface of the outside member 32b differ in position in the top-bottom direction, with the circular arc center C2 being above and the circular arc center C3 being below relatively.

A chassis opening 34 through which the flat cable 28 passes is formed in the rear edge portion 12d of the main body chassis 12. The respective chassis openings 34 are formed separately for the two flat cables 28A and 28B (see FIG. 4).

The cable guide 36 is provided inside the main body chassis 12 near the rear edge portion 12d. The cable guide 36 has a shape in which a center fixing piece 38, end fixing pieces 40 at both ends, and two blocks 42 are integrally molded and arranged in the left-right direction. The cable guide 36 is a resin material and can be manufactured at low cost by injection molding or the like. Each of the center fixing piece 38 and the end fixing pieces 40 has two screw holes 41, and are fixed to a pedestal 46 protruding from the inside surface 20a of the top cover member 20 by screws 44. One screw hole 41 in each end fixing piece 40 is directly fixed to the pedestal 46 by a screw 44, and the other screw hole 41 in each end fixing piece 40 is fastened together with the below-described bracket 52. The two screw holes 41 in the center fixing piece 38 are each fastened together with the bracket 52. The center fixing piece 38 is provided with a T-shaped hook 38a. Each end fixing piece 40 is provided with an L-shaped hook 40a. One tip protruding portion of each L-shaped hook 40a and a corresponding one of the two tip protruding portions of the T-shaped hook 38a at both ends protrude toward each other, i.e. protrude so as to face each other.

Each of the two blocks 42 is provided between the center fixing piece 38 and a corresponding one of the end fixing pieces 40 at both ends. Each of the two blocks 42 is slightly wider than the flat cable 28, and is located at such a position that guides the flat cable 28. Each block 42 includes a leg portion 48 that abuts the inside surface 22a of the bottom cover member 22, and a guide main portion 50 that protrudes forward from the top end of the leg portion 48. The leg portion 48 is provided along the rear edge portion 12d and closes the bottom part of the chassis opening 34. The leg portion 48 is short in the top-bottom direction and narrow in the front-rear direction.

The width of the guide main portion 50 in the top-bottom direction is greater than that of the leg portion 48, and is, for example, about 3 mm. The width of the guide main portion 50 in the front-rear direction is greater than that of the leg portion 48, and is, for example, about 7 mm. A front end portion 50a of the guide main portion 50 forms a circular arc surface, and its radius R1 is slightly smaller than the radii R2 and R3, and is, for example, 2 mm. The front end portion 50a forms a circular arc of approximately 90 degrees, and its bottom end smoothly continues with the bottom surface 50b of the guide main portion 50. A front top end portion 50d between the top surface 50c and the front end portion 50a of the guide main portion 50 forms a small circular arc. A rear top portion 50e of the guide main portion 50 is an inclined surface that descends in the rearward direction. The top surface 50c is located at approximately half the thickness of the main body chassis 12. The space 54 between the bottom surface 50b and the inside surface 22a of the bottom cover member 22 is narrow. The space 56 between the top surface 50c and the inside surface 20a of the top cover member 20 is relatively wide. The bottom surface 50b and the top surface 50c are parallel to the flat surface of the main body chassis 12 (that is, the plane in the front-rear direction and the left-right direction).

The flat cable 28 is fixed to the bottom surface 50b of the guide main portion 50 by the bracket 52. The respective brackets 52 are provided separately for the two pairs of flat cable 28 and guide main portion 50. Each bracket 52 is, for example, a thin metal plate, and includes a lateral extending portion 52a and screw receiving portions 52b at both ends of the lateral extending portion 52a. The width of the lateral extending portion 52a in the left-right direction is slightly longer than that of each of the flat cable 28 and the guide main portion 50. The width of the lateral extending portion 52a in the front-rear direction is slightly less than that of the bottom surface 50b, but is sufficient for stably holding the flat cable 28.

Each screw receiving portion 52b is slightly wider than the lateral extending portion 52a toward the front, and is fixed to the pedestal 46 together with a corresponding one of the center fixing piece 38 or the end fixing pieces 40 at both ends by screws 44 inserted through screw holes 52c. A small notch 52d that is engaged with the T-shaped hook 38a or the L-shaped hook 40a is formed at both ends of the bracket 52. The bracket 52 is accurately positioned by positioning pins 38b and 40b protruding from the cable guide 36.

The motherboard 29 is located at approximately half the thickness of the main body chassis 12. One end of the flat cable 28 is connected to a part near the rear end of the motherboard 29 by a connector 58. The rear end of the motherboard 29 and the guide main portion 50 are appropriately spaced apart. The flat cable 28 is gently inclined toward the inside surface 22a in the rearward direction from the position at which it is connected to the motherboard 29 by the connector 58, forms an S-shaped route length absorbing portion 60, and passes through the chassis opening 34 to come out of the main body chassis 12. The route length absorbing portion 60 is an extra length portion for absorbing changes in route length associated with angle changes when the main body chassis 12 and the display chassis 14 rotate relative to each other. The flat cable 28 coming out of the main body chassis 12 enters the hinge attachment portion 32 from the cable opening 32d, and the other end of the flat cable 28 is connected to the display 18 in the flat plate portion 30 through the cable hole 32c. The flat cable 28 is fixed inside the cable hole 32c with an adhesive material 62.

The route length absorbing portion 60 forms: a first extending portion 60a extending toward the rear edge portion 12d within the space 54; a second extending portion 60c extending from the first extending portion 60a through a first curved portion 60b toward the front; and a third extending portion 60e extending from the second extending portion 60c through a second curved portion 60d toward the rear edge portion 12d. The second extending portion 60c is sandwiched and fixed between the bottom surface 50b of the guide main portion 50 and the lateral extending portion 52a of the bracket 52.

As a result of the second extending portion 60c being fixed planarly by the bracket 52, the second curved portion 60d of the flat cable 28 curves along the front end portion 50a, separates from the front top end portion 50d, and extends over the top surface 50c, thus forming a forward convex circular arc of approximately 200 degrees. While at least the part of the second curved portion 60d along the front end portion 50a forms a circular arc with the radius R1, the second curved portion 60d as a whole also has approximately the radius R1 over a range of 200 degrees. The second curved portion 60d and the below-described third curved portion 60f do not need to be exactly circular arc-shaped, and only need to be substantially circular arc-shaped. The third extending portion 60e is slightly inclined downward in the rearward direction, but no interference occurs because the rear top portion 50e is inclined similarly.

The flat cable 28 abuts the inside member 32a in a part (referred to as “third curved portion 60f”) where it enters the hinge attachment portion 32 from the cable opening 32d beyond the route length absorbing portion 60. The inside member 32a forms a circular arc with the radius R2 at the cable opening 32d, and the third curved portion 60f forms a downward convex circular arc with the radius R2 along the inside member 32a. The third curved portion 60f in this case is about 90 degrees.

Since R1<R2 (=R3), at least in this state, the circular arc radius (R2) of the third curved portion 60f is larger than the circular arc radius (R1) of the second curved portion 60d. Given that the flat cable 28 has a certain degree of elasticity so as to return to its original shape and its elastic force depends on the degree of curvature, the restoring force of the second curved portion 60d is stronger than the restoring force of the third curved portion 60f. Moreover, the flat cable 28 is fixed so as to point forward in the second extending portion 60c. Therefore, the second curved portion 60d generates a force to return to a flat shape toward the front by overcoming the restoring force of the third curved portion 60f. This causes the third extending portion 60e to be pulled into the main body chassis 12 with appropriate tension, so that no unwanted slack occurs and the flat cable 28 is kept from protruding from the gap between the chassis 12 and 14.

As a result of the curved shape of the second curved portion 60d being regulated by the front end portion 50a of the guide main portion 50 with the circular arc radius R1, the restoring force of the second curved portion 60d can be adjusted appropriately in one or more embodiments. Even if the part corresponding to the front end portion 50a is omitted, the restoring force is still generated because the second extending portion 60c is fixed planarly by the bracket 52 and regulated so as to point forward, so that tension can be applied to the third extending portion 60e. Moreover, the second extending portion 60c is fixed to the bottom surface 50c of the guide main portion 50, that is, fixed at a position at least in the bottom half of the thickness of the main body chassis 12 in the top-bottom direction, above which a region for deformation and displacement of the second curved portion 60d and the third extending portion 60e (see FIGS. 2 and 3) is secured.

The second extending portion 60c is fixed so as to be parallel to the flat surface of the main body chassis 12. If conditions such as layout and assemblage permit, however, the second extending portion 60c may be angled away from the inside surface 20a (i.e. angled so as to approach the inside surface 22a) in the forward direction. This can further increase the restoring force of the second curved portion 60d. The second extending portion 60c is fixed planarly by the bracket 52 and thus its direction is stabilized and the fastening force is distributed planarly in one or more embodiments. Depending on conditions such as layout, however, appropriate effects can be achieved even when the second extending portion 60c is fixed linearly.

Since the second extending portion 60c in the S-shaped route length absorbing portion 60 is fixed, the second curved portion 60d is substantially the only part having the route length absorbing action. Compared to the case where there are a plurality of curved portions as in Japanese Unexamined Patent Application Publication No. 2022-121092, the shape is simple and the expected shape is maintained. This achieves, for example, the following effects: initial position setting for assembly is easy, the degree of curvature is not severe locally, contact with an unexpected part to cause abnormal noise does not occur, and the flat cable 28 is kept from protruding from the gap between the chassis 12 and 14. Since initial position setting for assembling the flat cable 28 in the electronic apparatus 10 is easy and the foregoing problems are prevented, inspection can be simplified and the frequency of reassembly, etc. can be reduced. The electronic apparatus 10 is thus suitable for mass production.

If R1<R2, the third extending portion 60e is pulled into the main body chassis 12 in one or more embodiments. Even if R1≥R2, however, the second curved portion 60d and the third curved portion 60f act to generate tension in the third extending portion 60e, with it being possible to prevent slack.

While R1<R2 in the entire angle range of relative rotation of the chassis 12 and 14 in one or more embodiments as described below, R1<R2 at least in a state in which the rotation angle is 0 degrees as illustrated in FIG. 2. This is because, if the third extending portion 60e is slack in this state, it is easily visible from the outside. In addition, since the electronic apparatus 10 may be carried in the state illustrated in FIG. 2, if the third extending portion 60e is slack, the third extending portion 60e is likely to come into contact with other objects being carried.

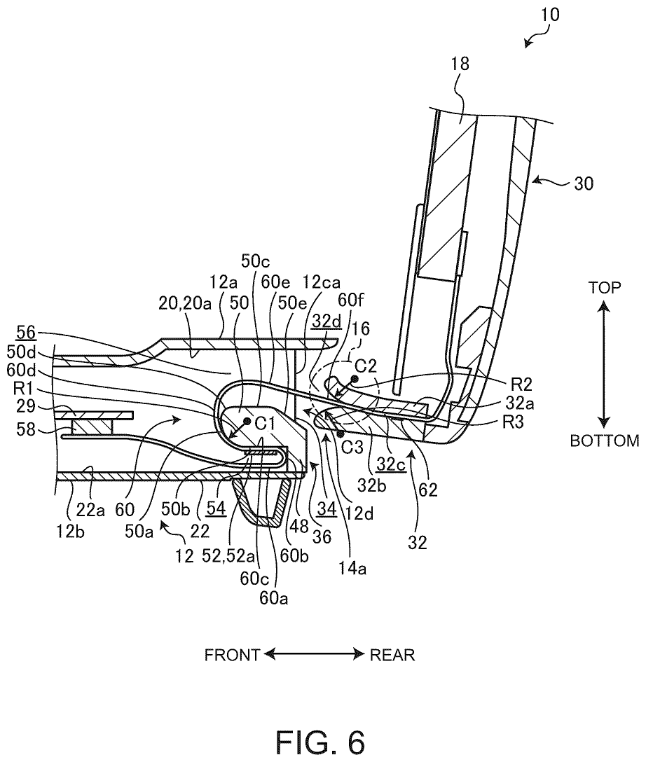

FIG. 6 is a sectional side view of the flat cable 28 and its surroundings in the electronic apparatus 10 in a state in which the rotation angle between the chassis 12 and 14 is 100 degrees. In this state, the flat cable 28 is separated from the inside member 32a and the outside member 32b in a part where the flat cable 28 enters the hinge attachment portion 32, and is linear on the extension of the third extending portion 60e. In other words, the third curved portion 60f here can be regarded as having an infinite circular arc radius and an angle of 0. In this case, the distance between the front end portion 50a of the guide main portion 50 and the adhesive material 62 is the shortest, and the circular arc radius of the second curved portion 60d is slightly larger in order to absorb the route length. Still, the circular arc shape is maintained and tension can be applied to the third extending portion 60e. In this case as well, the circular arc radius of the second curved portion 60d is smaller than the circular arc radius (infinite) of the third curved portion 60f in the part where the flat cable 28 is inserted into the cable opening 32d, so that the route length absorbing portion 60 has an action of pulling the third extending portion 60e into the main body chassis 12.

In the state illustrated in FIG. 6, the second curved portion 60d has an action of pulling the flat cable 28, whereas the third curved portion 60f has an infinite circular arc radius and has no pulling action. Thus, the flat cable 28 can be reliably pulled into the chassis 12. The state illustrated in FIG. 6 is close to a typical use state of the electronic apparatus 10. As a result of the third curved portion 60f having no pulling action at least in this state, the flat cable 28 can be prevented from slacking and annoying the user. The use state of the electronic apparatus 10 is commonly known to be about 90 degrees to 120 degrees in the rotation angle between the chassis 12 and 14.

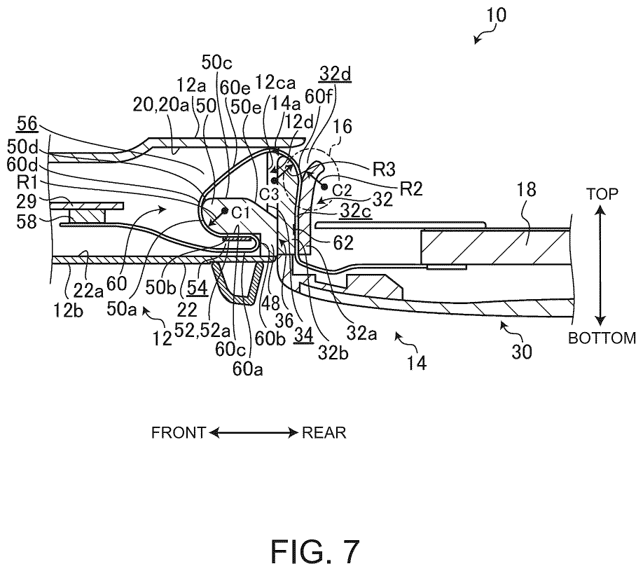

FIG. 7 is a sectional side view of the flat cable 28 and its surroundings in the electronic apparatus 10 in a state in which the rotation angle between the chassis 12 and 14 is 180 degrees. In this state, the third curved portion 60f of the flat cable 28 abuts the outside member 32b. The outside member 32b forms a circular arc with a radius R3 at the cable opening 32d, and the third curved portion 60f forms an upward convex circular arc with the radius R3 along the outside member 32b. In this case as well, the circular arc radius R1 of the second curved portion 60d is smaller than the circular arc radius R3 (=R2) of the third curved portion 60f, so that the route length absorbing portion 60 has an action of pulling the third extending portion 60e into the main body chassis 12.

The second curved portion 60d of the route length absorbing portion 60 has a circular arc radius R1 along the front end portion 50a of the guide main portion 50, as in FIG. 2. However, while the circular arc of the second curved portion 60d in FIG. 2 is approximately 200 degrees, the circular arc of the second curved portion 60d in FIG. 7 is approximately 130 degrees. The third curved portion 60f in this case is approximately 110 degrees. As a result of the second curved portion 60d being approximately 130 degrees, the third extending portion 60e is inclined upward in the rearward direction and its top end is substantially in contact with the inside surface 20a of the top cover member 20. The space 56 is thus effectively utilized. Since the flat cable 28 can come into contact with the inside surface 20a only at this moment, no abnormal noise due to sliding occurs.

While the cases where the rotation angle between the chassis 12 and 14 is 0 degrees (see FIG. 2), 100 degrees (see FIG. 6), and 180 degrees (see FIG. 7) have been described as examples, in one or more embodiments the second curved portion 60d has a smaller circular arc radius than the third curved portion 60f and has an action of pulling the third extending portion 60e into the main body chassis 12 in the entire angle range not limited to the foregoing angles. In particular, since the action of pulling the third extending portion 60e into the main body chassis 12 is continuously exerted over a rotation angle range of around 100 degrees at which the third curved portion 60f is linear, the direction of curvature of the third curved portion 60f can appropriately transition from convex downward to convex upward without being twisted. In the case of absorbing changes in route length by a plurality of curved portions as described in Japanese Unexamined Patent Application Publication No. 2022-121092, the shape may be unstable due to a wide operating angle. In one or more embodiments, on the other hand, the shape is stable in the range of 0 degrees to 180 degrees or over a wider operating range.

The restoring forces of the second curved portion 60d and the third curved portion 60f can be influenced not only by their circular arc radii but also by their circular arc angles. Conceptually, the restoring force is approximately inversely proportional to the circular arc radius and approximately proportional to the circular arc angle. In one or more embodiments, the second curved portion 60d has a smaller circular arc radius and a larger circular arc angle than the third curved portion 60f over the entire angle range, and the action of pulling the third extending portion 60e is reliably exerted. Thus, in the electronic apparatus 10, the route length absorbing portion 60 in the flat cable 28 can be maintained in an appropriate route to absorb route changes associated with changes in the rotation angle between the chassis 12 and 14. Here, as long as the restoring force based on the circular arc radius and the circular arc angle is larger in the second curved portion 60d than in the third curved portion 60f in the entire angle range or at least in predetermined angle states such as 0 degrees and 180 degrees, the second curved portion 60d may have a larger circular arc radius than the third curved portion 60f or have a smaller circular arc angle than the third curved portion 60f in a certain angle range.

The third curved portion 60f changes to increase in circular arc radius as the rotation angle between the chassis 12 and 14 increases from 0 degrees, and becomes linear at about 100 degrees. When the 100 degree state is exceeded, the circular arc of the third curved portion 60f turns into a curvature in the opposite direction. Due to the direction in which the second curved portion 60d and the third curved portion 60f are connected, the circular arc radius of the second curved portion 60d inevitably becomes smaller than the circular arc radius of the third curved portion 60f during this period. Thereafter, the circular arc radius of the second curved portion 60d changes to be larger and simultaneously the circular arc radius of the third curved portion 60f changes to be smaller. Thus, even if the circular arc radius size condition does not hold when the rotation angle is 0 degrees, there is always a range in which the circular arc radius size condition holds as a result of subsequent rotation. Therefore, depending on the design conditions, the circular arc radius of the curvature in the part where the flat cable 28 is inserted into the cable opening 32d may be larger than the circular arc radius of the second curved portion 40d at least in a predetermined angle range in which the pulling action of the flat cable 28 is to be controlled. More specifically, at least when the rotation angle is in the range of 90 degrees to 120 degrees, which is a typical use state, the flat cable 28 may be linear in the part where it is inserted into the cable opening 32d.

The present invention is not limited to the embodiments described above, and changes can be made freely without departing from the gist of the present invention.

### DESCRIPTION OF SYMBOLS

10 electronic apparatus
12 main body chassis
14 display chassis
16 hinge
18 display
20 top cover member
22 bottom cover member
28, 28A, 28B flat cable
30 flat plate portion
32 hinge attachment portion
32a inside member
32b outside member
32c cable hole
32d cable opening
34 chassis opening
36 cable guide
42 block
50 guide main portion
50a front end portion
50b bottom surface
50c top surface
50d front top end portion
50e rear top portion
52 bracket
54, 56 space
60 route length absorbing portion
60a first extending portion
60b first curved portion
60c second extending portion
60d second curved portion
60e third extending portion
60f third curved portion
62 adhesive material

What is claimed is:

1. An electronic apparatus comprising:
a first chassis;
a second chassis;
a hinge connecting the first chassis and the second chassis relatively rotatably; and
a flat cable provided across the first chassis and the second chassis,
wherein in the first chassis, the flat cable forms:
a first extending portion extending toward a first edge of the first chassis connected to the second chassis;
a second extending portion extending from the first extending portion through a first curved portion toward a side opposite to the first edge; and
a third extending portion extending from the second extending portion through a second curved portion toward the first edge, and
wherein the second extending portion is fixed.

2. The electronic apparatus according to claim 1, comprising
a block fixed to the first chassis and protruding from a vicinity of the first edge toward the side opposite to the first edge,
wherein a protruding end of the block regulates a curved shape of the second curved portion.

3. The electronic apparatus according to claim 2, wherein the second extending portion is fixed to the first chassis via the block.

4. The electronic apparatus according to claim 3, wherein the second extending portion is fixed planarly to the block.

5. The electronic apparatus according to claim 1, wherein the first chassis has a flat shape with a keyboard mounted on a top surface thereof, and
wherein the second extending portion is parallel to a flat surface of the first chassis or is at an angle so as to separate from the top surface in a direction toward the side opposite to the first edge.

6. The electronic apparatus according to claim 1, wherein the first chassis has a flat shape,
wherein the second chassis has a flat shape with a display in front, and includes a cable opening that is formed at a second edge of the second chassis connected to the first chassis and through which the flat cable is inserted, and
wherein at least in a state in which a display surface of the display overlaps the first chassis, a circular arc radius of a curvature of the flat cable in a part inserted into the cable opening is larger than a circular arc radius of the second curved portion.

7. The electronic apparatus according to claim 1, wherein the first chassis has a flat shape,
wherein the second chassis has a flat shape with a display in front, and includes a cable opening that is formed at a second edge of the second chassis connected to the first chassis and through which the flat cable is inserted, and
wherein at least in an angle range of 90 degrees to 120 degrees with respect to a state in which a display surface of the display overlaps the first chassis, the flat cable is linear in a part inserted into the cable opening.

8. The electronic apparatus according to claim 6, wherein in an entire angle range of relative rotation of the first chassis and the second chassis, the circular arc radius of the curvature of the flat cable in the part inserted into the cable opening is larger than the circular arc radius of the second curved portion.

9. The electronic apparatus according to claim 8, wherein in the entire angle range of relative rotation of the first chassis and the second chassis, a circular arc angle of the curvature of the flat cable in the part inserted into the cable opening is smaller than a circular arc angle of the second curved portion.

10. The electronic apparatus according to claim 1, wherein the first chassis is a main body chassis including a keyboard on a top surface thereof,
wherein the second chassis includes a flat plate portion that includes a display, and a bent portion that is bent from an end of the flat plate portion and, at a position facing the first edge of the main body chassis, connected to the hinge,
wherein the bent portion includes an inside member on a side facing the first edge and an outside member on a side opposite to the side facing the first edge, and a cable hole through which the flat cable passes is formed between the inside member and the outside member,
wherein at a cable opening from which the flat cable is inserted into the cable hole, the inside member and the outside member form respective circular arcs so as to widen from each other in a direction toward the opening, and
wherein a center of the circular arc of the inside member and a center of the circular arc of the outside member differ in position in an extending direction of the bent portion.

11. The electronic apparatus according to claim 1, wherein the first chassis is a main body chassis including a keyboard on a top surface thereof, and
wherein the second extending portion is fixed at a position in a bottom half of a thickness of the first chassis in a top-bottom direction.
